(19) United States
(12) Patent Application Publication
(10) Pub. No.: US 2016/0378738 A1
(43) Pub. Date: Dec. 29, 2016

(54) EDITING ONE OR MORE TEXT FILES FROM AN EDITING SESSION FOR AN ASSOCIATED TEXT FILE

(71) Applicant: International Business Machines Corporation, Armonk, NY (US)

(72) Inventors: Anna D. Derbakova, Durham, NC (US); Jerrod L. Lankford, Raleigh, NC (US); Pamela S. Ross, Raleigh, NC (US); Chase T. Thomas, Raleigh, NC (US)

(21) Appl. No.: 14/754,227

(22) Filed: Jun. 29, 2015

(51) Int. Cl. G06F 17/24; G06F 17/22; G06F 17/21; G06F 3/0484

(52) U.S. Cl. CPC G06F 17/24; G06F 3/04842; G06F 17/2211; G06F 17/218; G06F 17/2229

(57) ABSTRACT

According to one embodiment of the present invention, a system edits text from a file inline with text from another file. The system displays text comprising content of a text file in a user interface of an editor. In response to selection of a first item from the displayed text and activation of a control of the editor, the system accesses text associated with the selected item from a second text file. The system inserts the text associated with the selected item into the displayed text proximate the selected item and visually distinguishes the inserted text from the content of the first file. Changes to the inserted text are made in the editor. In response to activation of another control of the editor, the system modifies the second file in accordance with the changes. Embodiments of the present invention further include a method and computer program product for editing text files in substantially the same manners described above.

### BACKGROUND

Present invention embodiments relate to editing text files, and more specifically, to editing text from one or more text files from an editing session for an associated text file. The editing session virtually inserts text from the other text files and allows editing of the inserted text. The modifications of the editing session are applied to the corresponding text files.

Integrated development environments (e.g., Eclipse) and web development tools (e.g., Chrome DevTools) allow users to move the mouse pointer over a function name in a source code file and elect to open another file containing the source code for the function in a separate window or tab. A user may then edit one file or the other by switching between the windows or tabs. In a software development project with many functions and files, a developer may have to switch between a number of separate windows or tabs while maintaining a train of thought.

### SUMMARY

According to one embodiment of the present invention, a system edits text from a file inline with text from another file. The system displays text comprising content of a text file in a user interface of an editor. In response to selection of a first item from the displayed text and activation of a control of the editor, the system accesses text associated with the selected item from a second text file. The system inserts the text associated with the selected item into the displayed text proximate the selected item and visually distinguishes the inserted text from the content of the first file. Changes to the inserted text are made in the editor. In response to activation of another control of the editor, the system modifies the second file in accordance with the changes. Embodiments of the present invention further include a method and computer program product for editing text files in substantially the same manners described above.

### BRIEF DESCRIPTION OF THE DRAWINGS

Generally, like reference numerals in the various figures are utilized to designate like components.

FIG. 1 is a diagrammatic illustration of an example environment for an embodiment of the present invention.

FIG. 2 is a flow diagram illustrating an example manner of editing a text file from an editing session for an associated text file according to an embodiment of the present invention.

FIG. 3 is an illustration of an example manner of displaying content from an initial text file according to an embodiment of the present invention.

FIG. 4 is an illustration of an example manner of displaying content from a second text file inline with respect to content from an initial text file according to an embodiment of the present invention.

FIG. 5 is an illustration of an example manner of displaying content from a first, second, and third file nested inline according to an embodiment of the present invention.

### DETAILED DESCRIPTION

Present invention embodiments relate to editing text from one or more text files from an editing session for an associated text file. The editing session virtually inserts text from the other text files and allows editing of the inserted text. The modifications of the editing session are applied to the corresponding text files. For example, an embodiment of the present invention may enhance software development environments to allow developers to view a first source code file and make code changes to functions in different files as if those functions were in the first file. An editor may provide the user a visual representation of the first file as if functions referred to in the first file were inline. The source code need not be permanently refactored to store the function implementations in the first file. Rather, the result is that a different file—the file containing the source code for the function—may be modified while the editor is displaying the first file. This temporary visual in-lining of function code may be activated with keyboard shortcuts or other user input.

One aspect of a present invention embodiment is to relieve developers of having to switch back and forth between multiple files to view a function or the context in which the function is called. Another aspect is to provide developers a view a code for a function in context without having to permanently embed code from one file into another.

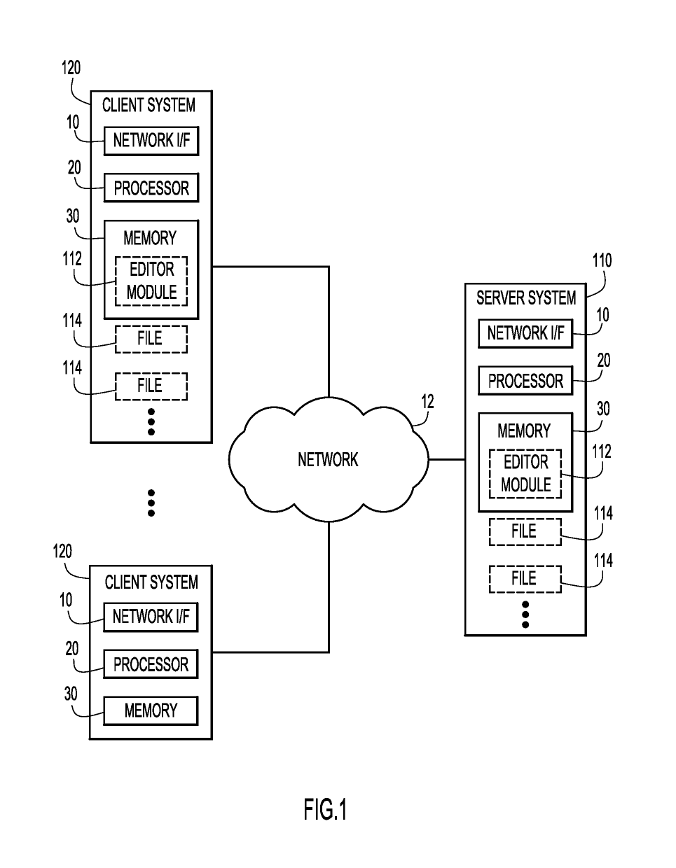

An example environment for present invention embodiments is illustrated in FIG. 1. Specifically, the environment includes server system 110, and one or more client or end-user systems 120. Server system 110 and client systems 120 may be remote from each other and communicate over a network 12. Network 12 may be implemented by any number of any suitable communications media (e.g., wide area network (WAN), local area network (LAN), Internet, intranet, etc.). Alternatively, any number of server systems 110, and/or client systems 120 may be local to each other, and communicate via any appropriate local communication medium (e.g., local area network (LAN), hardwire, wireless link, intranet, etc.).

A server system 110 may include an editor module 112 and two or more files 114. The editor module may be implemented across plural server systems. Alternatively, editor module 112 and/or files 114 may reside on a client system 120 or other computer system in communication with the client system.

Client systems 120 enable users to communicate with the editor module (e.g., via network 12). The client systems may present any graphical user (e.g., GUI, etc.) or other interface (e.g., command line prompts, menu screens, etc.) to receive commands from users and interact with the editor module and/or other modules or services.

Server systems 110 and client systems 120 may be implemented by any conventional or other computer systems preferably equipped with a display or monitor, a base (e.g., including at least one processor 20, memories 30 and/or internal or external network interface or communications devices 10 (e.g., modem, network cards, etc.)), optional input devices (e.g., a keyboard, mouse, or other input device), and any commercially available and custom software (e.g., editor software, software development software, database software, etc.)).

The editor module may include one or more modules or units to perform the various functions of present invention embodiments described below (e.g., determining selected items of text, accessing text related to a selected item, managing editor buffers, displaying text, mapping cursor positions to and from corresponding buffered text, saving changes, etc.), may be implemented by any combination of any quantity of software and/or hardware modules or units, and may reside within memory 30 of a server system and/or client systems for execution by processor 20.

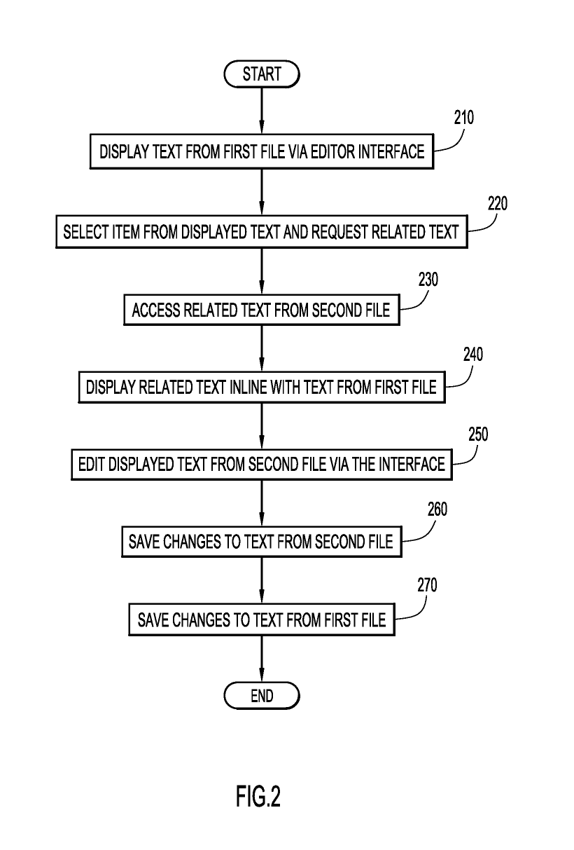

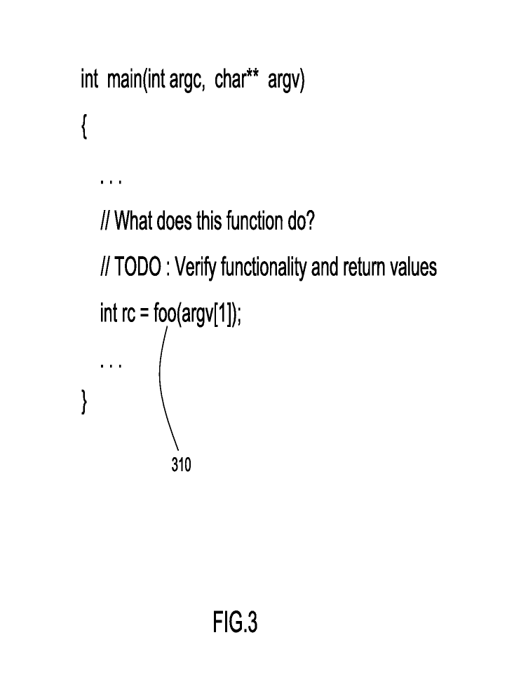

An example manner of editing text (e.g., via server system 110 and/or client system 120) according to an embodiment of the present invention is illustrated in FIG. 2. Initially, a user opens a first text file 114 (e.g., a source code file) via editor module 112. The editor module accesses the file and displays a view of the content to the user via an interface of the editor at step 210. For example, the first text file may be a source code file, and the displayed code (FIG. 3) may include a function name 310 (“foo”), method name, or other identifier. The editor module may use a conventional or other editor buffer (e.g., gap buffer, rope, linked list, etc.) to store content of the file for editing and display. In addition, the editor module may parse the content of the file to find identifiers and/or identifier types (e.g., object names, object classes, method names, function names, etc.).

The user may select an item of text (e.g., an occurrence of a function name, method name, or other identifier) in the display (e.g., by highlighting, clicking on, or placing the mouse over the item) and activate a control (e.g., a command button, hot key, etc.) to request additional text related to the selected item at step 220. For example, the user may select function name 310 (“foo”) and activate a control to access the source code for that function inline.

In response, the editor module accesses text related to the selected item from a second file at step 230. The editor module may read the related text into the same buffer used for the original content or a separate buffer, and may maintain metadata mapping the buffers or buffer portions to the corresponding text files. The editor module may identify the location of the related text (e.g., the name of the second file, the location of the related text within the second file, etc.) using conventional or other techniques. For example, in a source code editor embodiment, a function's source code may be found using conventional software development environment tools.

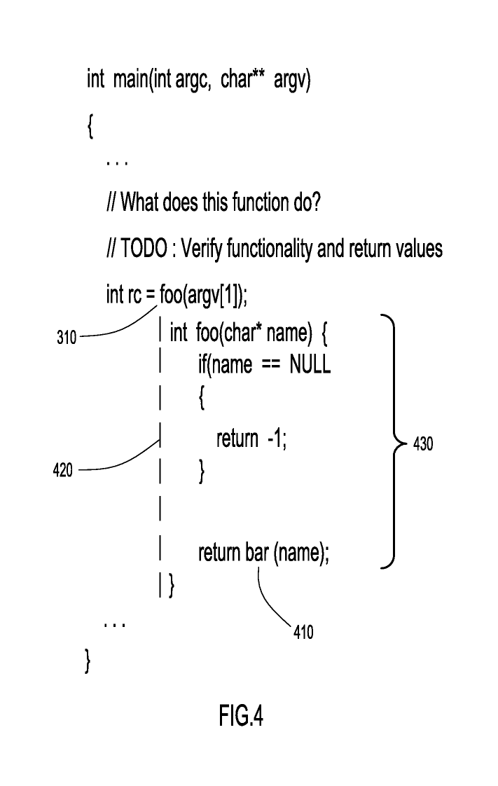

At step 240, the editor module displays the related text from the second file inline with text from the first file. The inline text may be displayed proximate to the selected item of text and in a manner that visually distinguishes text of the first file from text of the second file. For example, the text 430 (FIG. 4) defining the function foo may be displayed below the line containing the selected instance of the function name 310. To visually distinguish text 430 of the second file from surrounding text of the first file, each line of text 430 may be preceded by a marker 420 (e.g., the character ‘|’) aligned horizontally with the beginning of the selected text item. Alternatively, an embodiment may visually distinguish the inserted text in any other manner (e.g., by background color, text or foreground color, text font, text size, a surrounding box, other text alignment or indentation relative to neighboring text, other marker positions, etc.).

A user may edit the inline-displayed text from the second file via the editor interface (e.g., in a manner similar to that by which the user may text from the first file). The editor module receives a change to the inline-displayed text from the second file via the editor interface at step 250. When the user enters changes, selects text, or otherwise interacts with displayed text via the editor interface, the editor module may determine the location of the cursor on the screen, and map the determined location to the editor buffer or buffer position corresponding to the displayed text with which the user interacts. For example, the user may edit text 430 to change the implementation of the function foo. The editor maps those changes to the buffer for text 430 (and hence to the second file). The corresponding editor buffer or buffer portion, and the display, may be updated accordingly.

The user may elect to save changes to the text from the second file at step 260. For example, the user may activate a control to save changes. In response, the editor module writes changes to the inline-displayed text from the second file back to the second file. For example, the editor may write changes in the buffer or buffer portion for text 430 to the second file, containing the source code for the function foo. In response to activation of the same control (or a different control), the editor module writes changes to text from the first file back to the first file at step 270.

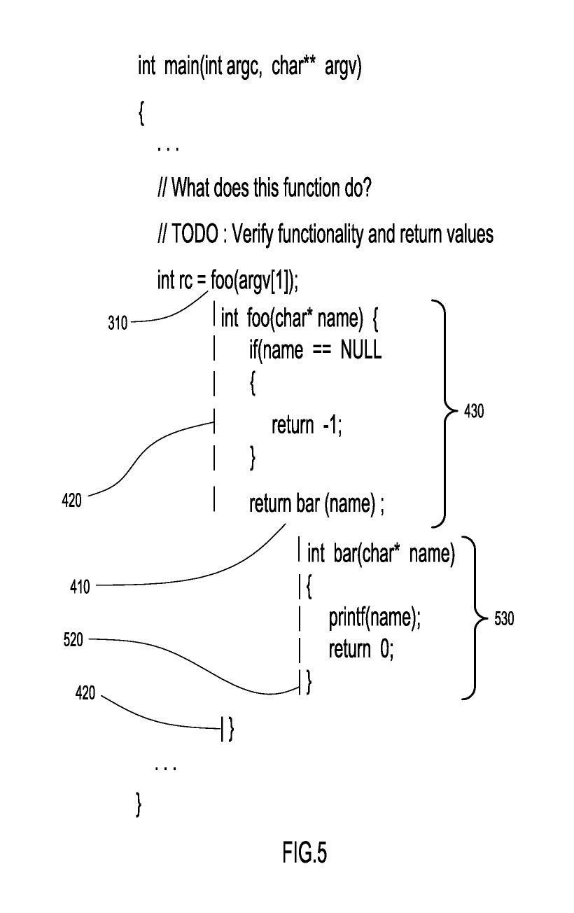

A user may select any number of items in the display and may edit the text associated with each before or after saving changes. For example, after selecting function name 310 (“foo”) and viewing or editing the associated text 430, the user may select another function name (e.g., function name 410 (“bar”)) displayed in the editor interface and edit text 530 (FIG. 5) implementing that function. The text associated with each additional selected item (e.g., text 510 associated with function name 430) may be accessed, displayed, edited, and saved in a manner similar to that described with respect to text 430. Text associated with an additional selected items (e.g., text 510 associated with function name 410) may reside in the same file as text 430 or another file. The additional items of text (e.g., function name 410) may be selected from the displayed text of the first file or from inline-displayed text of another file (e.g., from text 430 of the second file).

When the user selects an item from inline-displayed text and activates the control to access related text, the editor module may display the related text in a manner that indicates the nested relations of the inline texts associated with the selected items. For example, when the user selects function name 410 (“bar”) from inline-displayed text 430, the associated text 530 (the source code for the function bar), may be displayed below the line containing the selected function name 410 (“bar”), and each line of text 530 may be preceded by a marker 520 (e.g., the character ‘|’) aligned horizontally with the beginning of the selected function name 410 (“bar”). This allows the user to conveniently view the code path hierarchy (e.g., relation of the code from the functions main to foo to bar).

Accordingly, present invention embodiments provide for editing one or more text files from an editing session for an associated text file, rather than from a plurality of editor sessions using different windows or tabs. As a result, present invention embodiments improve the functioning of computing systems (e.g., server system 110, client system 120, or other systems that provide a software development environment or other application supporting text editing) by reducing the memory and processing overhead incurred by multiple concurrent editor sessions and windows or tabs. For example, in a software development environment with graphical user interfaces and back ends for editing, compiling, linking, and debugging, the reducing the memory footprint may reduce virtual memory usage and thereby improve the environment's responsiveness.

It will be appreciated that the embodiments described above and illustrated in the drawings represent only a few of the many ways of implementing embodiments for editing one or more text files from an editing session for an associated text file.

The environment of the present invention embodiments may include any number of computer or other processing systems (e.g., client or end-user systems, server systems, etc.) and storage systems (e.g., file systems, databases, or other repositories), arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., database software, communications software, etc.). These systems may include any types of monitors and input devices (e.g., keyboard, mouse, voice recognition, touch screen, etc.) to enter and/or view information.

It is to be understood that the software of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for editing any type of text or other data (e.g., source code for a function, a phone number, etc.) from one file including related text or other data (use of a function, a person's name, etc.) inserted in any fashion from one or more other files or storage units.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C±+ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. (canceled)

2. (canceled)

3. (canceled)

4. (canceled)

5. (canceled)

6. (canceled)

7. (canceled)

8. (canceled)

9. A system for editing text files comprising:
at least one processor configured to:
display text in a user interface of an editor, wherein the displayed text comprises content of a first file;
in response to selection of a first item from the displayed text and activation of a first control of the editor, access text associated with the selected first item from a second file;
insert the text associated with the selected first item into the displayed text proximate to the first item and visually distinguish the inserted text from the content of the first file;
receive a change to the inserted text via the editor;
in response to activation of a second control of the editor, modify the second file in accordance with the received change.

10. The system of claim 9, wherein the at least one processor is further configured to:
in response to selection of a second item from the displayed text and activation of the first control of the editor, access text associated with the second item from a corresponding file;
insert the text associated with the second item into the displayed text proximate to the second item and visually distinguish the inserted text associated with the second item from neighboring content in the user interface;
receive changes to the inserted text associated with the second item via the user interface;
in response to activation of the second control of the editor, modify the corresponding file in accordance with the received change to the text associated with the second item.

11. The system of claim 10, wherein the second item is selected from the inserted text associated with the selected first.

12. The system of claim 11, wherein visually distinguishing the inserted text associated with the second item from neighboring content in the user interface comprises visually indicating nested insertions of the text associated with the first item and the text associated with the second item.

13. The system of claim 9, wherein visually distinguishing the inserted text from the content of the first file comprises indenting the inserted text relative to neighboring content.

14. The system of claim 9, wherein visually distinguishing the inserted text from the content of the first file comprises a selected one of displaying a marker to indicate inserted lines of text, displaying the inserted text with a distinguishing background color, displaying the inserted text with a distinguishing foreground color, displaying the inserted text with a distinguishing font.

15. The system of claim 9, further wherein the at least one processor is further configured to modify the first file in accordance with the received change to displayed content of the first file.

16. The system of claim 9, wherein the first and second files comprise computer source code files, the selected first item comprises a name of a function, and the text associated with the first item comprises computer code to implement the function.

17. A computer program product for editing text files comprising:
a computer readable storage medium having computer readable program code embodied therewith for execution on a processing system, the computer readable program code comprising computer readable program code configured to:
display text in a user interface of an editor, wherein the displayed text comprises content of a first file;
in response to selection of a first item from the displayed text and activation of a first control of the editor, access text associated with the selected first item from a second file;
insert the text associated with the selected first item into the displayed text proximate to the first item and visually distinguish the inserted text from the content of the first file;
receive a change to the inserted text via the editor;
in response to activation of a second control of the editor, modify the second file in accordance with the received change.

18. The computer program product of claim 17, wherein the second item is selected from the inserted text associated with the selected first, and the computer readable program code is further configured to:
in response to selection of a second item from the displayed text and activation of the first control of the editor, access text associated with the second item from a corresponding file;
insert the text associated with the second item into the displayed text proximate to the second item and visually distinguish the inserted text associated with the second item from neighboring content in the user interface;
receive changes to the inserted text associated with the second item via the user interface;
in response to activation of the second control of the editor, modify the corresponding file in accordance with the received change to the text associated with the second item.

19. The computer program product of claim 18, wherein visually distinguishing the inserted text associated with the second item from neighboring content in the user interface comprises visually indicating nested insertions of the text associated with the first item and the text associated with the second item.

20. The computer program product of claim 17, wherein:
the computer readable program code is further configured to modify the first file in accordance with the received change to displayed content of the first file;
visually distinguishing the inserted text from the content of the first file comprises:
indenting the inserted text relative to neighboring content; and
a selected one of displaying a marker to indicate inserted lines of text, displaying the inserted text with a distinguishing background color, displaying the inserted text with a distinguishing foreground color, displaying the inserted text with a distinguishing font; and
the first and second files comprise computer source code files, the selected first item comprises a name of a function, and the text associated with the first item comprises computer code to implement the function.
